(19) United States
(12) Patent Application Publication
(10) Pub. No.: US 2016/0250555 A1
(43) Pub. Date: Sep. 1, 2016

(54) VIDEO GAME PROCESSING PROGRAM AND VIDEO GAME PROCESSING SYSTEM

(71) Applicant: KABUSHIKI KAISHA SQUARE ENIX (also trading as SQUARE ENIX CO., LTD.), Tokyo (JP)

(72) Inventors: Hiroki FUJIMOTO, Tokyo (JP); Takashi TOKITA, Tokyo (JP); Hideo IWASAKI, Tokyo (JP); Koki TAKAHASHI, Tokyo (JP); Kohei MIYAZAKI, Tokyo (JP)

(73) Assignee: KABUSHIKI KAISHA SQUARE ENIX (also trading as SQUARE ENIX CO., LTD.), Tokyo (JP)

(21) Appl. No.: 15/045,682

(22) Filed: Feb. 17, 2016

(30) Foreign Application Priority Data
Feb. 26, 2015 (JP) 2015-036682

(51) Int. Cl. A63F 13/537; A63F 13/42; A63F 13/2145

(52) U.S. Cl. CPC A63F 13/537; A63F 13/2145; A63F 13/42

(57) ABSTRACT

A non-transitory computer-readable medium including a video game processing program product for causing a server to realize functions to control progress of a video game in response to an operation inputted to a terminal provided with a touch panel is provided. In this case, the functions include: a specifying function configured to specify an effect for which an exerting condition is satisfied in accordance with progress of the video game; an appearing function configured to cause a plurality of icons corresponding to the effect to respectively appear at a plurality of positions in a game screen; and an exerting function configured to exert, when any icon is selected, the effect independently of a position of the selected icon.

### CROSS-REFERENCE TO RELATED APPLICATION

The present application relates to subject matter contained in Japanese Patent Application No. 2015-36682 field on Feb. 26 2015, the disclosure of which is expressly incorporated herein by reference in its entirety.

### BACKGROUND OF THE INVENTION

1. Field of the Invention

At least one of embodiments according to the present invention relates to a non-transitory computer-readable medium including a video game processing program and a video game processing system for causing a server to realize functions to control progress of a video game in response to an operation inputted to a terminal provided with a touch panel.

2. Description of the Related Art

Heretofore, various kinds of systems for providing a video game that can be played on a mobile terminal or the like provided with a touch panel have been proposed.

In such systems, for example, there is one in which, when a player taps an icon indicating a kind of attack, an attack is changed in accordance with the kind of tapped icon (see Japanese Patent Application Publication No. 2010-017395).

However, in the conventional system, there has been a problem that a player may not be able to operate an icon displayed on a game screen smoothly. Namely, for example, in a video game in which a player is required to move his or her finger within a game screen right and left, an impression that visibility and/or operability of an icon is reduced may be given to the player.

### SUMMARY OF THE INVENTION

It is an object of at least one of embodiments according to the present invention to solve the problem described above, and to provide a player with a video game, in which an icon with high functionality or convenience is displayed on a game screen.

According to one non-limiting aspect of the present invention, there is provided a non-transitory computer-readable medium including a video game processing program product for causing a server to realize functions to control progress of a video game in response to an operation inputted to a terminal provided with a touch panel. In this case, the functions include: a specifying function configured to specify an effect for which an exerting condition is satisfied in accordance with progress of the video game; an appearing function configured to cause a plurality of icons corresponding to the effect to respectively appear at a plurality of positions in a game screen; and an exerting function configured to exert, when any icon is selected, the effect independently of a position of the selected icon.

According to another non-limiting aspect of the present invention, there is provided a video game processing system including a communication network, a server and a user terminal, the video game processing system being configured to control progress of a video game in response to an operation inputted to a user terminal provided with a touch panel, the video game processing system including: a specifying section configured to specify an effect for which an exerting condition is satisfied in accordance with progress of the video game; an appearing section configured to cause a plurality of icons corresponding to the effect to respectively appear at a plurality of positions in a game screen; and an exerting section configured to exert, when any icon is selected, the effect independently of a position of the selected icon.

According to still another non-limiting aspect of the present invention, there is provided a non-transitory computer-readable medium including a video game processing program product for causing a server to realize a first group of functions to control progress of a video game in response to an operation inputted to a terminal provided with a touch panel, the video game processing program further causing the terminal to realize a second group of functions to carry out the video game, wherein the first group of functions includes: a specifying function configured to specify an effect for which an exerting condition is satisfied in accordance with progress of the video game; an appearing function configured to cause a plurality of icons corresponding to the effect to respectively appear at a plurality of positions in a game screen; and an exerting function configured to exert, when any icon is selected, the effect independently of a position of the selected icon, wherein the second group of functions includes: a receiving function configured to receive information for outputting the game screen received from the server.

According to each of the embodiments of the present application, one or two or more shortages are solved.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings:

FIG. 1 is a block diagram showing an example of a configuration of a video game processing system corresponding to at least one of embodiments according to the present invention.

FIG. 2 is a block diagram showing a configuration of a video game processing server corresponding to at least one of the embodiments according to the present invention.

FIG. 3 is a flowchart showing an example of game processing corresponding to at least one of the embodiments according to the present invention.

FIG. 4 is a flowchart showing an example of an operation of a server side in game processsing corresponding to at least one of embodiments according to the present invention.

FIG. 5 is a flowchart showing an example of an operation of a terminal side in the game processing corresponding to at least one of the embodiments according to the present invention.

FIG. 6 is a block diagram showing a configuration of the video game processing server corresponding to at least one of the embodiments according to the present invention.

FIG. 7 is a flowchart showing an example of the game processing corresponding to at least one of the embodiments according to the present invention.

FIG. 8 is a block diagram showing a configuration of the video game processing server corresponding to at least one of the embodiments according to the present invention.

FIG. 9 is a flowchart showing an example of the game processing corresponding to at least one of the embodiments according to the present invention.

FIG. 10 is a block diagram showing a configuration of the video game processing server corresponding to at least one of the embodiments according to the present invention.

FIG. 11 is a flowchart showing an example of the game processing corresponding to at least one of the embodiments according to the present invention.

FIG. 12 is a block diagram showing a configuration of the video game processing server corresponding to at least one of the embodiments according to the present invention.

FIG. 13 is an explanatory drawing for explaining an example of a storage state of information corresponding to at least one of the embodiments according to the present invention.

FIG. 14 is a flowchart showing an example of the game processing corresponding to at least one of the embodiments according to the present invention.

FIG. 15 is a block diagram showing a configuration of the video game processing server corresponding to at least one of the embodiments according to the present invention.

FIG. 16 is a flowchart showing an example of the game processing corresponding to at least one of the embodiments according to the present invention.

FIG. 17 is an explanatory drawing for explaining an example of a game screen corresponding to at least one of the embodiments according to the present invention.

FIG. 18 is an explanatory drawing for explaining an example of the game screen corresponding to at least one of the embodiments according to the present invention.

### DETAILED DESCRIPTION OF THE INVENTION

Hereinafter, examples of embodiments according to the present invention will be described with reference to the drawings. In this regard, various kinds of elements in an example of each embodiment, which will be described below, can appropriately be combined with each other in a range where contradiction or the like does not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like does not occur in the content of the processing.

### FIRST EMBODIMENT

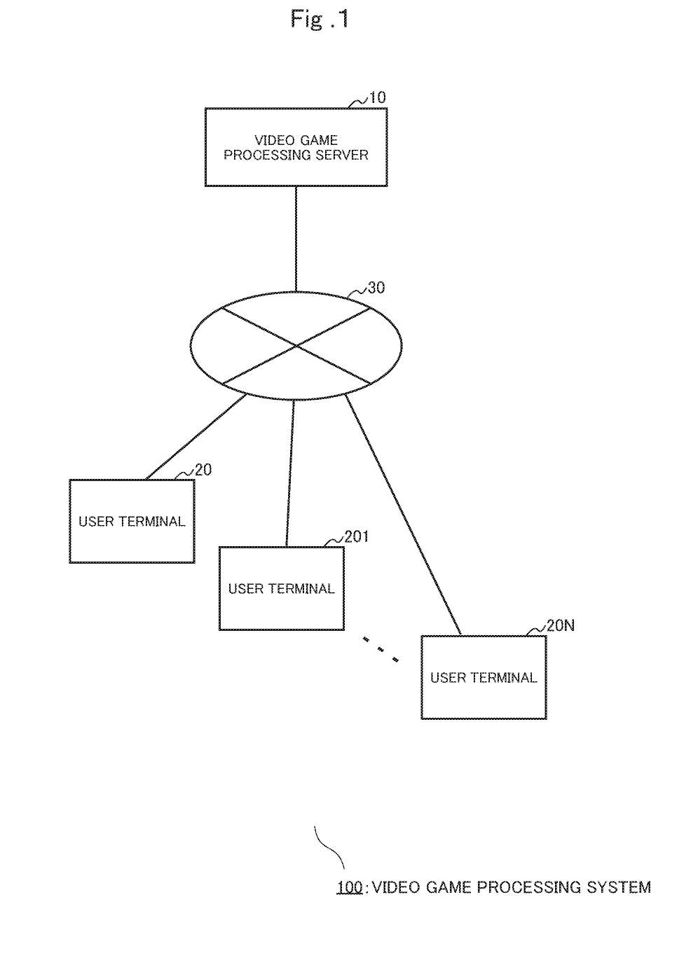

FIG. 1 is a block diagram showing an example of a configuration of a video game processing system 100 according to one embodiment of the present invention. As shown in FIG. 1, the video game processing system 100 includes a video game processing server 10, and user terminals 20 and 201 to 20N (“N” is an arbitrary integer) respectively used by a plurality of users (players) who play a video game. In this regard, the configuration of the video game processing system 100 is not limited to this configuration. The video game processing system 100 may be configured so that the plurality of users uses a single user terminal, or may be configured so as to include a plurality of servers.

Each of the video game processing server 10 and the plurality of user terminals 20 and 201 to 20N is connected to a communication network 30 such as the Internet. In this regard, although it is not shown in the drawings, the plurality of user terminals 20 and 201 to 20N is connected to the communication network 30 by carrying out data communication with base stations managed by a telecommunication carrier by means of a radio communication line.

The video game processing system 100 includes the video game processing server 10 and the plurality of user terminals 20, 201 to 20N, whereby various kinds of functions for controlling progress of the video game in response to an operation of the user are realized.

The video game processing server 10 is managed by an administrator of the video game processing system 100, and has various kinds of functions to provide information regarding the video game to the plurality of user terminals 20, 201 to 20N. In the present embodiment, the video game processing server 10 is constructed by an information processing apparatus, such as a WWW server, and includes a storage medium for storing various kinds of information. In this regard, the video game processing server 10 is provided with a general configuration for carrying out the video game, such as a control section and a communicating section. However, its explanation herein is omitted. Further, in the video game processing system 100, it is preferable that the video game processing server 10 manages information regarding the video game from a point of view to reduce a processing load on each of the plurality of user terminals 20, 201 to 20N. However, the storage section for storing the various kinds of information may include a storage region with a state that the video game processing server 10 can access the storage region. For example, the video game processing server 10 may be configured so as to be provided with a dedicated storage region outside the video game processing server 10.

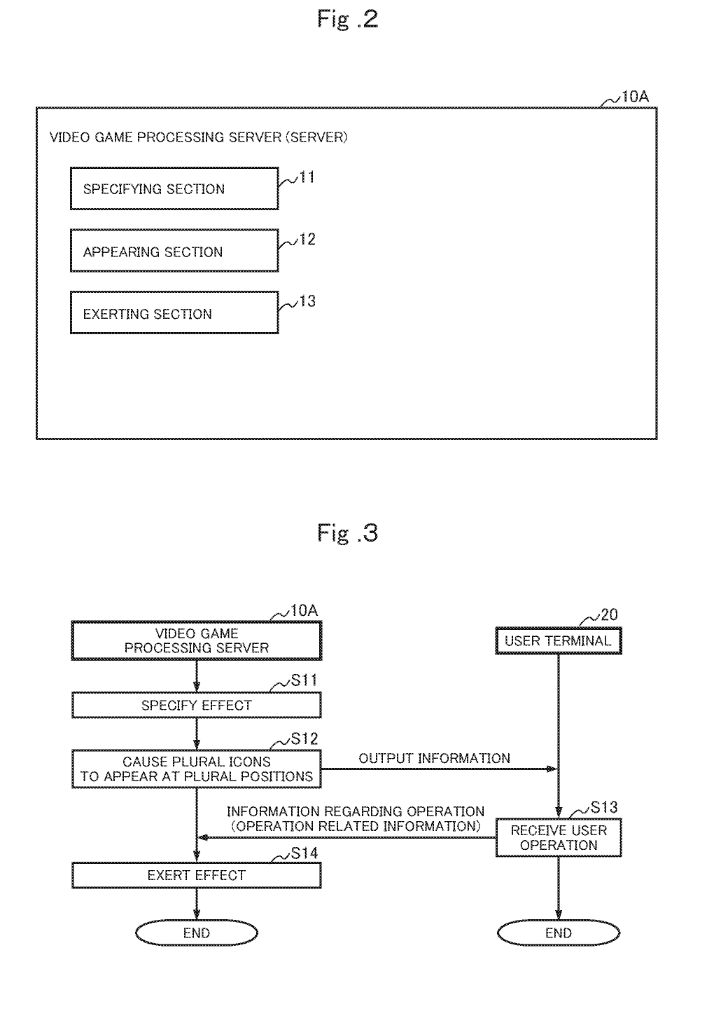

FIG. 2 is a block diagram showing a configuration of a video game processing server 10A (hereinafter, referred to as a “server 10A”) that is an example of the configuration of the video game processing server 10. The server 10A at least includes a specifying section 11, an appearing section 12, and an exerting section 13.

The specifying section 11 has a function to specify an effect for which an exerting condition is satisfied in accordance with progress of the video game.

Here, the content of the exerting condition and the effect is not limited particularly. However, it is preferable that the video game processing system 100 is configured so that the same effect can be exerted only in a case where the exerting condition is satisfied again after exertion of the effect.

Further, the word “in accordance with progress of the video game” means that occurrence of each of various kinds of progresses or changes, which can occur in the video game, is regarded as an opportunity and a standard of specific processing. As examples of the specific processing, there are determining processing, information updating processing, and the like. Further, as examples of the various kinds of progresses or changes that can occur in the video game, there are progress of time, a change in a game element value, update of a specific status or a flag, an operation input by the user, and the like.

The appearing section 12 has a function to cause a plurality of icons corresponding to an effect to respectively appear at a plurality of positions in a game screen.

Here, the icon means an image by which a selection operation by the player can be received. A form of the icon is not limited particularly. However, it is preferable that the form of the icon is a form by which the player can be informed that the effect can be exerted. As examples of the icon, there are a normal virtual button and a figure by which the content of effect can be presented to the player. Further, as an example of the selection operation by the player, there is an operation (touch operation) of the player who touches an icon by means of a finger or the like when the icon is displayed on a touch panel. In this regard, the video game processing system 100 may be configured so that the touch operation herein means an operation of the player who touches a display position of the icon by means of the finger or the like. Alternatively, the video game processing system 100 may be configured so that the touch operation herein means an operation in which the player touches a display position of the icon by means of the finger or the like and then releases the finger or the like from the display position.

The exerting section 13 has a function to exert or show, when any icon is selected, an effect independently of a position of the selected icon.

Here, the word “exert or show an effect” means that processing associated with an icon selected by the player in advance is carried out.

Further, the word “independently of a position of the selected icon” means that a plurality of icons corresponding to one activating condition is displayed on the game screen and the same effect is exerted when any icon is selected. In this case, the effect is exerted so that there is no difference between a case where one icon is selected and a case where the other icon is selected in the video game. Namely, for example, the present embodiment is not intended to exclude a configuration, in which representation for one icon selected by the player different from the other icons is carried out of a plurality of icons, from a technical scope.

Each of the plurality of user terminals 20, 201 to 20N is managed by a user (or player) who plays the video game, and is configured by a communication terminal, such as a cellular phone terminal, a PDA (Personal Digital Assistants), and a mobile game device, by which the user can play a network delivery type game, for example. In this regard, the configuration of the user terminal that the video game processing system 100 can include is not limited to the examples described above. However, the user terminal may be configured so that the user can recognize the video game. As the other example of the configuration of the user terminal, there is a so-called wearable divide such as a smart watch, a combination of the wearable device and a communication terminal, and the like.

Further, each of the plurality of user terminals 20, 201 to 20N is connected to the communication network 30, and includes hardware (for example, a display device for displaying a game screen, an audio output device and the like) and software for carrying out the video game by communicating with the video game processing server 10. In this regard, each of the plurality of user terminals 20, 201 to 20N may be configured so as to directly communicate with each other without the video game processing server 10. Further, the configuration of each of the plurality of user terminals 20, 201 to 20N for receiving a user operation at least includes the touch panel corresponding to the game screen.

Next, an operation of the video game processing system 100 (hereinafter, referred to as the “system 100”) according to the present embodiment will be described.

FIG. 3 is a flowchart showing an example of game processing carried out by the system 100. In the game processing according to the present embodiment, processing related to appearance of icons and exertion of an effect is carried out. Hereinafter, a case where the server 10A and the user terminal 20 (hereinafter, referred to as the “terminal 20”) carry out the game processing as processing related to cloud gaming will be described as an example.

The game processing is started in a case where an exerting condition of an effect is satisfied in accordance with progress of the video game, for example.

In the game processing, the server 10A first specifies an effect for which an exerting condition is satisfied (Step S11). In the present embodiment, the server 10A refers to a predetermined storage region in which an effect and an exerting condition are stored so as to be associated with each other, and specifies the effect.

When the effect is specified, the server 10A cause a plurality of icons corresponding to the effect to respectively appear at a plurality of positions in a game screen (Step S12). In the present embodiment, the server 10A generates information (output information) for outputting a game screen, in which a plurality of icons is arranged at a plurality of positions in the game screen in accordance with a predetermined arranging rule, to the terminal 20, and transmits the generated output information to the terminal 20.

When the output information is received from the server 10A, the terminal 20 receives a user operation (Step S13). In the present embodiment, the terminal 20 outputs a game screen on the basis of received output information, generates information regarding the user operation received via the touch panel (operation related information), and transmits the generated operation related information to the server 10A.

When the operation related information is received from the terminal 20, the server 10A exerts the effect on the basis of the received operation related information (Step S14). In the present embodiment, the server 10A carries out processing regarding exertion of the effect, and terminates the processing herein.

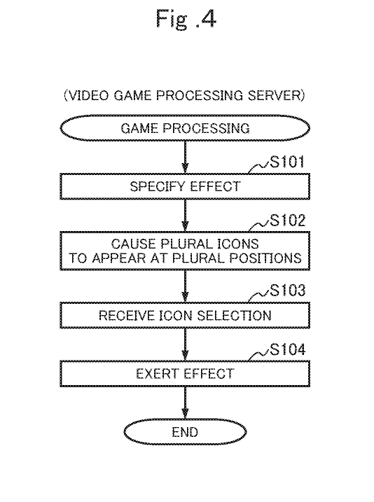

FIG. 4 is a flowchart showing an example of an operation of the server 10A side in the game processing. Here, the operation of the server 10A according to the video game processing system 100 will be described again.

In the game processing, the server 10A first specifies an effect for which an exerting condition is satisfied (Step S101), and causes the plurality of icons corresponding to the specified effect to respectively appear at the plurality of positions in the game screen (Step S102).

When the icons are caused to appear in the game screen, the server 10A receives an icon selection by the user from the user terminal communicated for outputting a game screen (Step S103). In the present embodiment, the server 10A receives information for identifying the icon selected by the user.

When the icon selection by the user is received, the server 10A exerts the effect corresponding to the icon selected by the user (Step S104), and terminates the processing herein.

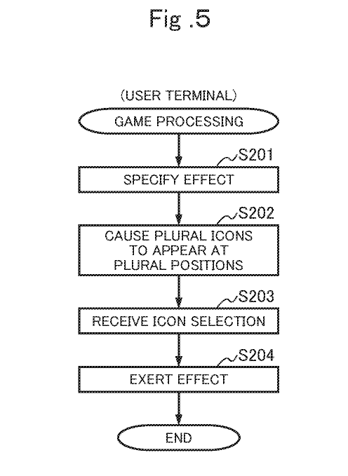

FIG. 5 is a flowchart showing an example of an operation of the terminal 20 side in a case where the terminal 20 carries out the game processing. Hereinafter, a case where the terminal 20 carries out the game processing by a single body will be described as an example.

In the game processing, the terminal 20 first specifies an effect for which an exerting condition is satisfied (Step S201), and cause a plurality of icons corresponding to the specified effect to respectively appear at a plurality of positions in a game screen (Step S202).

When the icon is caused to appear on the game screen, the terminal 20 receives an icon selection by the user (Step S203), exerts the effect corresponding to the icon selected by the user (Step S204), and terminates the processing herein.

As explained above, as one side of the first embodiment, the video game processing server 10A for controlling progress of the video game in response to an operation inputted to the terminal provided with the touch panel is configured so as to include the specifying section 11, the appearing section 12, and the exerting section 13. Therefore, it is possible to provide the players with the video game, in which the effect for which the exerting condition is satisfied in accordance with progress of the video game is specified; the plurality of icons corresponding to the effect is caused to respectively appear at the plurality of positions in the game screen; when any icon is selected, the effect is exerted independently of the position of the icon; and the icon with high functionality or convenience is thereby displayed on the game screen.

Namely, the icons by each of which the same effect is to be exerted respectively appear at the plurality of positions. Therefore, it becomes possible for the player to select one icon that appears at a posit ion that the player readily selects. For that reason, for example, it can be said that convenience of the icons is improved compared with an icon that appears only at a fixed position in the game screen.

### SECOND EMBODIMENT

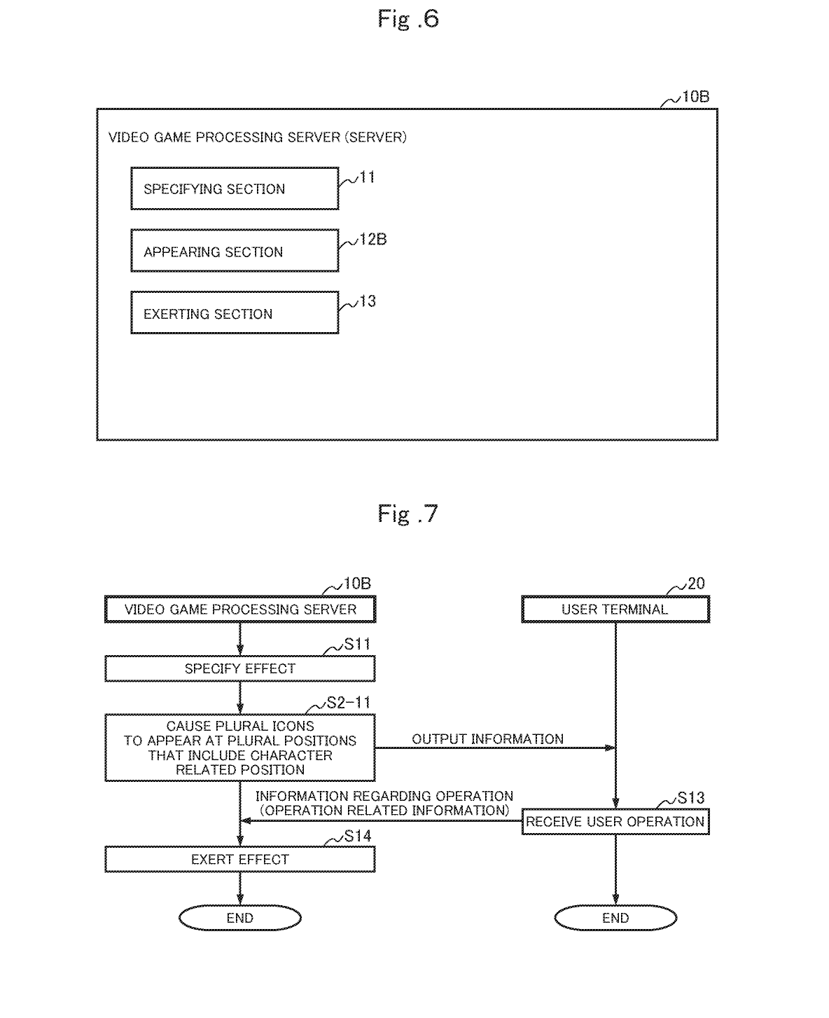

FIG. 6 is a block diagram showing a configuration of a video game processing server 10B (hereinafter, referred to as a “server 10B”), which is an example of the video game processing server 10. In the present embodiment, the server 10B at least includes a specifying section 11, an appearing section 12B, and an exerting section 13.

The appearing section 12B has a function to cause icons to respectively appear at a plurality of positions including at least one of positions specified on the basis of a position of a character operated by a player of a video game (hereinafter, referred to as a “character related position”).

Here, the character related position may be a position by which a user can recognize that the character related position is related to the position of the character. A method of specifying the position is not limited particularly. As an example of the character related position, there is a vicinity of the character on a game screen. Further, the video game processing system 100 may be configured so that, in a case where the character or the game screen scrolls in one direction, an opposite position to the scrolling direction with respect to the character is specified as the character related position. By configuring the video game processing system 100 in this manner, it is possible to improve visibility of the game screen. Namely, for example, it can be said that visibility of the game screen is improved because the icon covers a part of the virtual space newly displayed as the game screen by scrolling compared with a case where an icon is caused to appear at a position of the same side as that of the scrolling direction with respect to the character.

FIG. 7 is a flowchart showing an example of the game processing carried out by the system 100. Hereinafter, operations of the server 10B and the terminal 20 will be described as an example. In this regard, a flowchart showing an operation of each of the server 10B and the terminal 20 will be omitted from a point of view to avoid repeated explanation.

When the effect for which the exerting condition is satisfied is specified (Step S11), the server 10B cause icons to respectively appear at the plurality of positions including at least one of the specified position on the basis of a position of the character operated by the player of the video game (Step S2-11). In the present embodiment, the server 10B generates information (output information) for causing the terminal 20 to output a game screen in which the icons corresponding the effect for which the exerting condition is satisfied are respectively arranged at the plurality of positions including the character related position, and transmits the generated output information to the terminal 20.

As explained above, as one side of the second embodiment, the video game processing server 10B is configured so as to include the specifying section 11, the appearing section 12B, and the exerting section 13. Therefore, the icons can be caused to respectively appear at the plurality of positions including at least one of the positions specified on the basis of the position of the character operated by the player of the video game, and this makes it possible to cause icons to respectively appear at positions that the player who takes notice of the character recognizes easily.

### THIRD EMBODIMENT

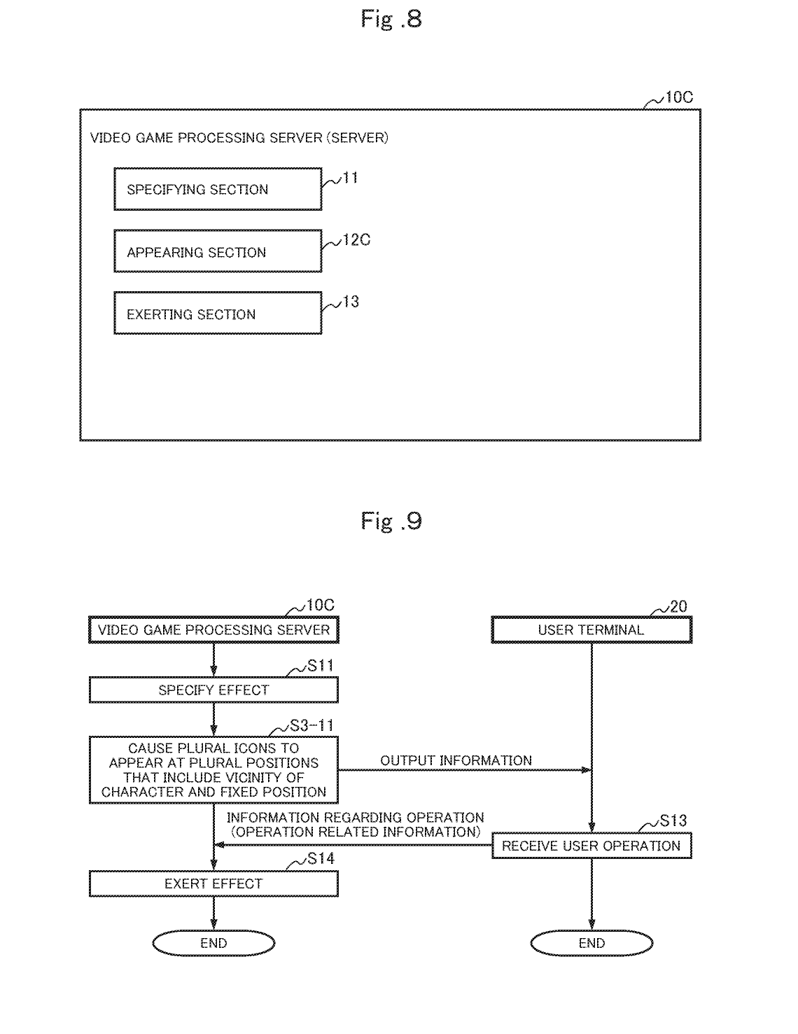

FIG. 8 is a block diagram showing a configuration of a video game processing server 10C (hereinafter, referred to as a “server 10C”), which is an example of the video game processing server 10. In the present embodiment, the server 10C at least includes a specifying section 11, an appearing section 12C, and an exerting section 13.

In the present embodiment, an area in which a character operated by the player of the video game can move (hereinafter, referred to as a “first area”) and an area in which information regarding the character is displayed (hereinafter, referred to as a “second area”) are provided in the game screen (not shown in the drawings).

Here, a character (that is, an image of the character) is arranged in the first area. In this regard, a form of the first area outputted to the terminal 20 is not limited particularly. However, for example, the form of the first area may be a form in which the character is arranged at the center and a background thereof is scrolled. Alternatively, the form of the first area may be a form in which the character is moved in response to a player operation with respect to a background that scrolls in accordance with an elapse of time.

Further, the content of the information displayed in the second area is not limited particularly. As examples of the displayed information, there are a so-called status, progress of the video game, and an item.

The appearing section 12C has a function to cause the icons to respectively appear at the plurality of positions including a vicinity of the character in the first area and a fixed position provided in the second area.

Here, the word “vicinity of the character” means a position at which the player can recognize that the icon is displayed near the character. Namely, for example, the video game processing system 100 may be configured so that a part or all of the icons is displayed so as to be superimposed on the character in a display screen of the terminal 20.

Further, the fixed position in the second area means a position defined in advance as a position at which an icon is caused to appear. Namely, for example, the video game processing system 100 may be configured so that the icons are displayed statically in the second area of the display screen of the terminal 20, or so that the icons are displayed dynamically.

Further, the definition of different positions of the vicinity of the character and the fixed position in the second area is not limited particularly. However, the video game processing system 100 may be configured so that the two positions including the vicinity of the character and the fixed position in the second area are used as the plurality of positions. As examples of the position used as one of the plurality of positions, there are a fixed position in the first area, a position specified by the player, a position specified at random by using random numbers, or a position specified on the basis of a position of other object in the game screen.

FIG. 9 is a flowchart showing an example of the game processing carried out by the system 100. Hereinafter, operations of the server 100 and the terminal 20 will be described as an example. In this regard, a flowchart showing an operation of each of the server 10C and the terminal 20 is omitted from a point of view to avoid repeated explanation.

When the effect for which the exerting condition is satisfied is specified (Step S11), the server 10C causes the icons to respectively appear at the plurality of positions including the vicinity of the character in the first area and the fixed position provided in the second area (Step S3-11). In the present embodiment, the server 100 generates information (output information) for outputting a game screen, in which the icons corresponding to the effect for which the exerting condition is satisfied are respectively arranged at the plurality of positions including the vicinity of the character and the fixed position in the second area, to the terminal 20, and transmits the generated output information to the terminal 20.

As explained above, as one side of the third embodiment, the video game processing server 10C is configured so as to include the specifying section 11, the appearing section 12C, and the exerting section 13. Therefore, the icons can be caused to respectively appear at the plurality of positions including the vicinity of the character in the area in which the character operated by the player of the video game can move in the game screen and the fixed position provided in the area in which information regarding the character is displayed. This makes it possible for the player to select an icon displayed at a position, which the player feels easy to operate, of the plurality of positions for which definitions are different.

Namely, the same effect is exerted even though any icon is selected so long as the selected icon is any of the icons caused to appear in the game screen due to the same condition. Therefore, it becomes possible for the player to select an icon that the player feels instinctive selectable.

### FOURTH EMBODIMENT

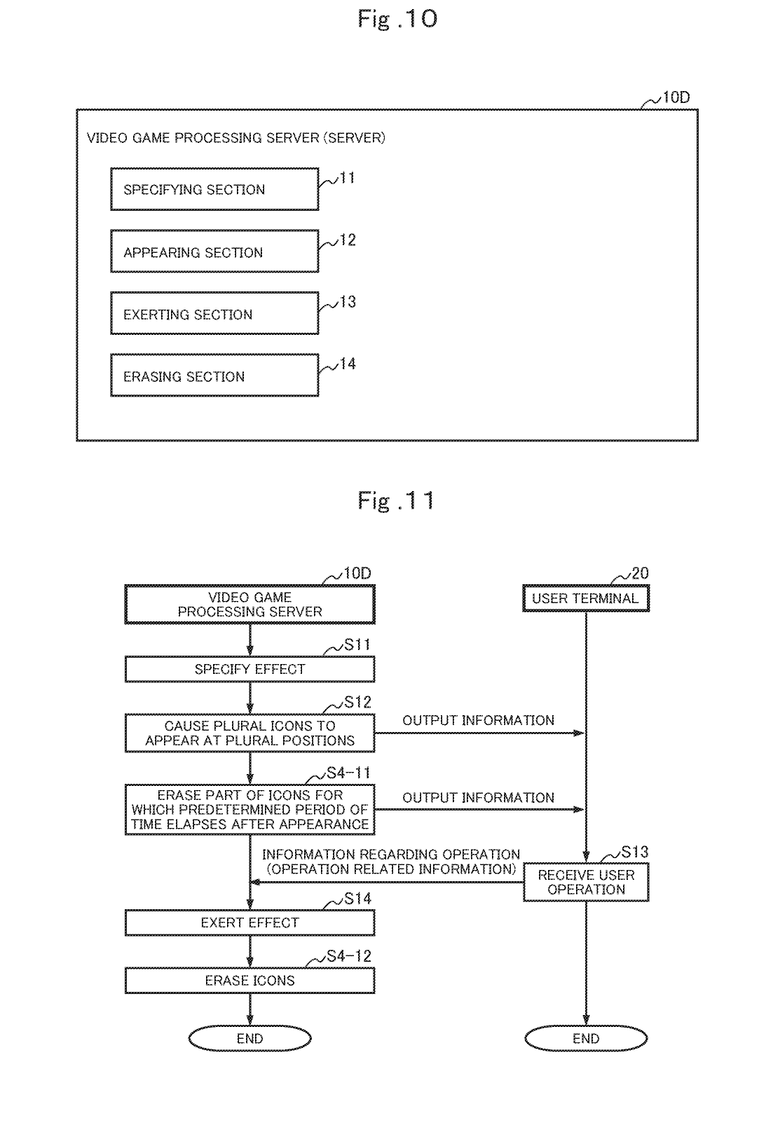

FIG. 10 is a block diagram showing a configuration of a video game processing server 10D (hereinafter, referred to as a “server 10D”), which is an example of the video game processing server 10. In the present embodiment, the server 10D at least includes a specifying section 11, an appearing section 12, an exerting section 13, and an erasing section 14.

The erasing section 14 has a function to erase a part of the icons from the game screen when a predetermined period of time elapses since the icon is caused to appear by the function of the appearing section 12. Further, the erasing section 14 also has a function to erase all of the icons corresponding to the effect from the game screen when the effect is exerted by the function of the exerting section 13.

Here, a length of a predetermined period of time is not limited particularly. However, for example, the video game processing system 100 may be configured so that the player is allowed to set up a length of a predetermined period of time.

Further, the part of the icons means a part of icons corresponding to the effect for which the exerting condition is satisfied. Namely, in the present embodiment, at least one icon corresponding to the effect for which the exerting condition is satisfied is caused to appear on the game screen.

Further, the word “erase an icon” means that the icon is set up from a selectable state to a non-selectable state. Namely, for example, transition from a state where the icon is displayed in color to a state where the icon is displayed in monochrome may be included in the “erase” according to the present embodiment.

FIG. 11 is a flowchart showing an example of the game processing carried out by the system 100. Hereinafter, operations of the server 10D and the terminal 20 will be described as an example. In this regard, a flowchart showing an operation of each of the server 10D and the terminal 20 is omitted from a point of view to avoid repeated explanation.

When the plurality of icons corresponding to the effect are cause to respectively appear at the plurality of positions in the game screen (Step S12), the server 10D erases a part of the icons from the game screen when a predetermined period of time elapses since the icons were caused to appear (Step S4-11). In the present embodiment, the server 10D generates information (output information) for outputting a game screen, in which a part of the icons that is caused to appear and a predetermined period of time then elapses is erased, to the terminal 20, and transmits the generated output information to the terminal 20.

Further, in the present embodiment, when the effect is exerted on the basis of the operation related information received from the terminal 20 (Step S14), the server 10D erases all of the icons corresponding to the exerted effect from the game screen (Step S4-12). In the present embodiment, the server 10D generates information for outputting a game screen in which the icon is erased to the terminal 20, transmits the generated information to the terminal 20, and terminates the processing herein.

As explained above, as one side of the fourth embodiment, the video game processing server 10D is configured so as to include the specifying section 11, the appearing section 12, the exerting section 13, and the erasing section 14. Therefore, the part of icons can be erased from the game screen when a predetermined period of time elapses since the icon was caused to appear, and all of the icons corresponding to the effect can be erased from the game screen when the effect is exerted. Thus, it is possible to setup a difference of a period of time for appearance between a plurality of icons. This makes it possible to prevent visibility of the game screen from being reduced due to the fact that icons that have not been selected are displayed forever.

In this regard, it has not been mentioned particularly in the example of the fourth embodiment described above. However, the server 10D may be configured so as to: erase an icon that is caused to appear at a position on which a player's point of view tends to focus in a case where a predetermined period of time elapses; and cause icons displayed at positions on which the player's point of view hardly focuses to appear until the effect is exerted. By configuring the server 10D in this manner, it is possible to improve operability of the icons and visibility of the game screen. In this regard, as an example of the position on which a viewpoint of the player focuses, there is a vicinity of the player character. Further, as an example of the position on which the viewpoint of the player hardly focuses, there is the fixed position different from the vicinity of the player character. Here, as an example of the different fixed position, there is a position within an area different from an “area showing the virtual space including the player character” in the game screen. Namely, for example, the video game processing system 100 may be configured so that, in a case where a virtual space display area, a status display area, and a bar (so-called side bar) for receiving an operation to change a drawing range of the virtual space are provided in one game screen, the icon caused to appear on the status display area or the bar is caused to appear until the effect is exerted.

### FIFTH EMBODIMENT

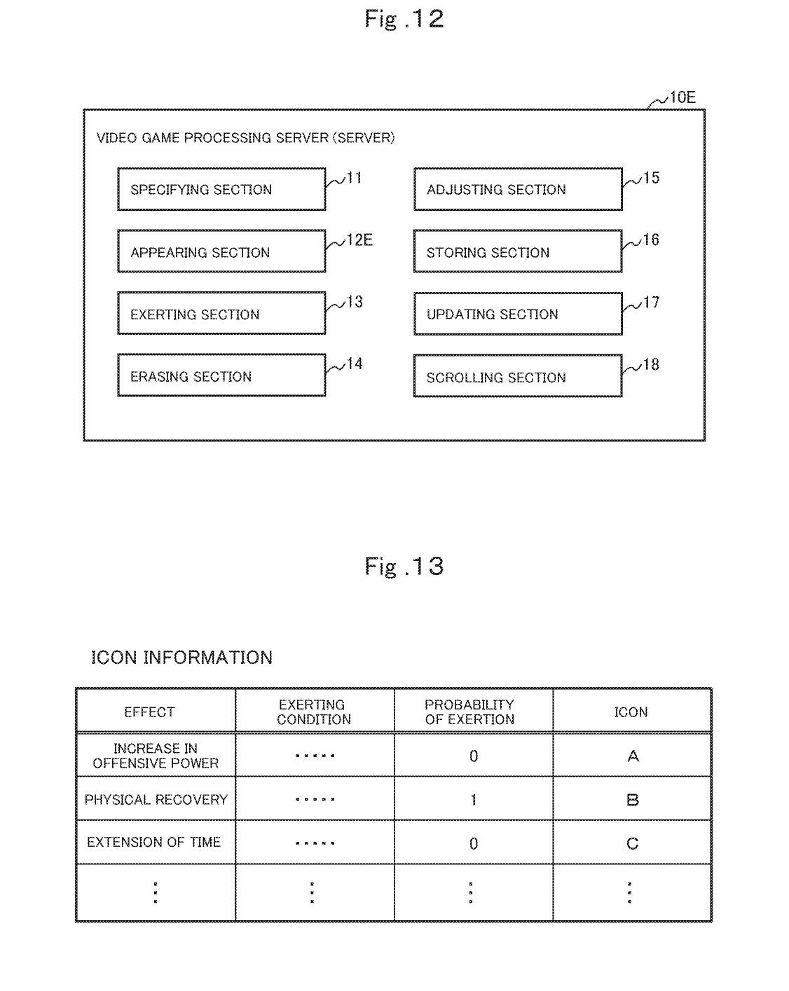

FIG. 12 is a block diagram showing a configuration of a video game processing server 10E (hereinafter, referred to as a “server 10E”), which is an example of the video game processing server 10. In the present embodiment, the server 10E at least includes a specifying section 11, an appearing section 12E, an exerting section 13, an erasing section 14, an adjusting section 15, a storing section 16, an updating section 17, and a scrolling section 18.

The appearing section 12E has a function to change a display form of a predetermined object in a game screen when an icon is caused to appear.

Here, the predetermined object is not limited particularly so long as it is an object that exists in the game screen before appearance of the icons. As an example of the predetermined object, there is an object related to an effect in the video game.

Further, the appearing section 12E has a function to return, when the effect is exerted by the function of the exerting section 13, the display form of the predetermined object to the state before the change. Namely, in the present embodiment, the player can visually recognize a state of the predetermined object by means of the function of the appearing section 12E, and can determine probability of exertion of the effect. In this regard, the content of a change in the display form is not limited particularly. However, there is replacement of the icon caused to appear, for example.

Further, the appearing section 12E has a function to cause, when to cause a plurality of icons corresponding to an effect for which an exerting condition is satisfied to respectively appear at a plurality of positions in the game screen, the icon that was erased in accordance with an elapse of a predetermined period of time and for which the corresponding effect has not been exerted to appear in the game screen again.

Here, the appearing section 12E causes an icon to appear at a position before erasing the icon when the icon is caused to appear again. In this regard, the display form when the icon is caused to appear again is not limited particularly. However, for example, the video game processing system 100 may be configured so that the display form is the same display form between at the first time and twice or more, or they are different display forms therebetween.

The adjusting section 15 has a function to adjust visibility of an icon.

Here, the word “adjust” means that a form of an icon is changed. Its concrete content is not limited particularly so long as it is one whose visibility with respect to the player can be changed. As an example of adjusting, there is a change in a form (for example, a shape, a color, and transparency). In this regard, timing to adjust visibility of the icon is not limited particularly. However, it is preferable that it is a condition for being capable of suggesting a remaining time until a part of the icons erases to the player, or a condition for heightening visibility of the game screen. As examples of the adjusting condition, there are an elapsed time since the icon is caused to appear and a progress status of the video game.

Further, the adjusting section 15 has a function to reduce visibility of an icon by changing a form of the icon in accordance with progress of the video game.

Here, the configuration to reduce visibility is not limited particularly. As examples of the change, there are a rise in transparency, monochromatic, and partially transparent (for example, to become a state where a part thereof is hollowed out).

The storing section 16 has a function to store a plurality of effects, exerting conditions of the respective effects, icons respectively corresponding to the effects, and probability of exertion of each of the effects so as to be associated with each other. Each of the effects can be exerted in accordance with progress of the video game.

FIG. 13 is an explanatory drawing for explaining an example of a storage state of information stored in the storing section 16. As shown in FIG. 13, the storing section 16 stores an effect, an exerting condition, probability of exertion, and an icon so as to be associated with each other as information regarding an icon (hereinafter, referred to as “icon related information”). In this regard, in the present embodiment, “1” is set to an exertable effect, and “0” is set to a non-exertable effect.

The updating section 17 has a function to update probability of exertion of an effect when the effect is specified by the function of the specifying section 11 and when the effect is exerted by the function of the exerting section 13.

The scrolling section 18 has a function to scroll the display content in the virtual space in accordance with progress of the video game.

Here, the virtual space means a space in which a character of the video game exists virtually. The configuration of the virtual space is not limited particularly so long as it is a configuration in which a game screen can be generated. However, the configuration may be a two-dimensional space or a three-dimensional space, for example.

Further, the word “scroll the display content in the virtual space” means that the drawing range is moved with respect to the game screen in which the virtual space is drawn.

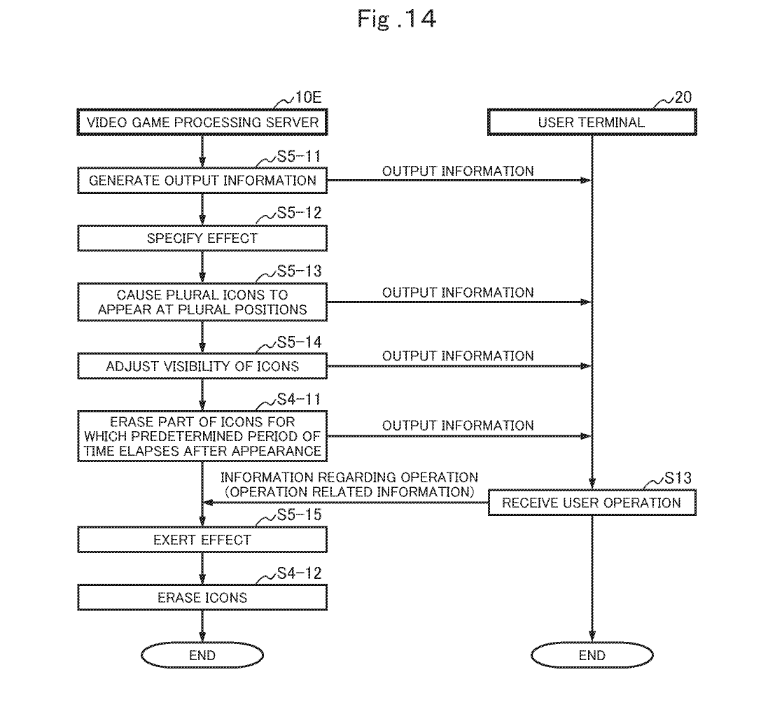

FIG. 14 is a flowchart showing an example of the game processing carried out by the system 100. Hereinafter, operations of the server 10E and the terminal 20 will be described as an example. In this regard, a flowchart showing an operation of each of the server 10E and the terminal 20 is omitted from a point of view to avoid repeated explanation. Further, description of “generation of output information” may be omitted.

The server 10E generates output information according to progress of the video game (Step S5-11). In the present embodiment, the server 10E generates information (output information) for outputting a game screen, in which the display content of the virtual space is scrolled in accordance with progress of the video game, to the terminal 20, and transmits the generated output information to the terminal 20. Further, the server 10E appropriately refers to the icon related information, and determines whether there is an effect for which an exerting condition is satisfied or not.

In a case where it is determined that there is an effect for which an exerting condition is satisfied, the server 10E specifies the effect for which the exerting condition is satisfied (Step S5-12). In the present embodiment, the server 10E updates the icon related information so that the user is allowed to identify that the effect for which the exerting condition is satisfied is in an exertable state.

When the effect for which the exerting condition is satisfied is specified, the server 10E causes a plurality of icons to respectively appear at the plurality of positions (Step S5-13). In the present embodiment, the server 10E carries out, in addition to processing regarding new appearance of icons, processing regarding the display form of the predetermined object and the icons erased in the process at Step S4-11.

When the icon is caused to appear, the server 10E adjusts visibility of the icon (Step S5-14). In the present embodiment, the server 10E reduces transparency of the icon on the basis of a predetermined adjustment condition.

Further, when the operation related information is received from the terminal 20, the server 10E exerts the effect on the basis of the received operation related information (Step S5-15). In the present embodiment, as part of the processing regarding exertion of the effect, the server 10E updates the icon related information so that “probability of exertion” corresponding to the exerted effect becomes from “1” to “0”. Further, the server 10E returns the object whose display form is changed to an original state when the exerted effect is caused to appear.

As explained above, as one side of the fifth embodiment, the video game processing server 10E is configured so as to include the appearing section 12E. Therefore, the icon can be caused to respectively appear at the plurality of positions including at least one of the positions specified on the basis of the position of the character operated by the player of the video game; the icons can be caused to respectively appear at the plurality of positions including a position that can become a point of fixation of the player; and the player can be caused to recognize appearance of the icons easily.

Further, the server 10E is configured so as to include the appearing section 12E. Therefore, the display form of the predetermined object in the game screen can be change when the icon is caused to appear; the display form of the predetermined object can be returned to a state before change when the exerting function exerts the effect; and this makes it possible for the player to recognize appearance of the icons easily on the basis of the display form of the predetermined object.

Further, the server 10E is configured so as to include the appearing section 12E. Therefore, when the plurality of icons corresponding to the effect for which the exerting condition is satisfied is caused to respectively appear at the plurality of positions in the game screen, the icons that were erased in accordance with an elapse of the predetermined period of time and for which the corresponding effect has not been exerted can be caused to appear in the game screen again. This makes it possible to effectively prevent the player from forgetting the effect for which the exerting condition is satisfied.

Further, the server 10E is configured so as to include the storing section 16 and the updating section 17. Therefore, a plurality of effects each of which can be exerted in accordance with progress of the video game, an exerting condition of each of the effects, an icon corresponding to each of the effects, and probability of exertion of each of the effects can be stored so as to be associated with each other. When any effect is specified and the specified effect is exerted, the probability of exertion of the effect can be updated. This makes it possible to manage the probability of exertion of each of the plurality of effects accurately.

Further, the server 10E is configured so as to include the scrolling section 18. Therefore, the display content of the virtual space can be scrolled in accordance with progress of the video game. This makes it possible to provide, to the player, the video game that is a so-called scrolling game and in which the plurality of icons corresponding to the same effect can be displayed.

In this regard, it has not been mentioned particularly in the example of the fifth embodiment described above. However, the server 10E may be configured so as to cause an icon to appear at a position of the periphery of the player character that is different from a scrolling direction. In this case, for example, the server 10E may be configured so as to cause icons to appear at an upper side of the player character when to scroll the display content of the virtual space in a direction toward downward of the display screen. This makes it possible to prevent the icon from disappearing from the game screen by scrolling, and to prevent visibility from being reduced.

### SIXTH EMBODIMENT

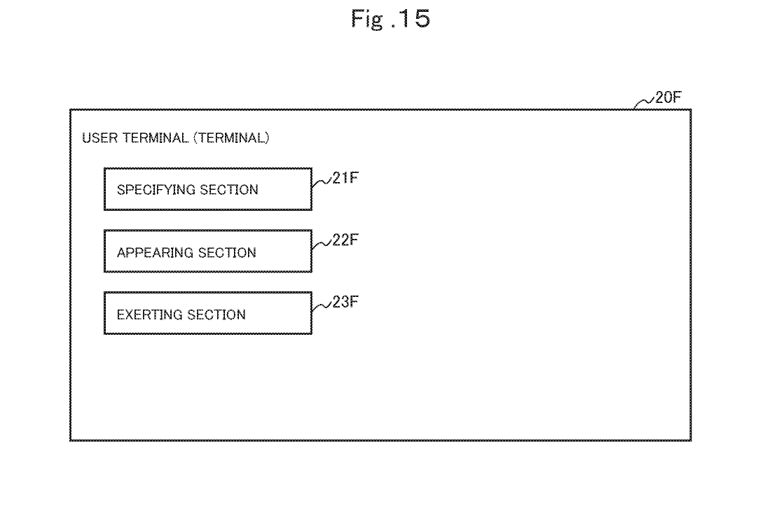

FIG. 15 is a block diagram showing a configuration of a user terminal 20F (hereinafter, referred to as a “terminal 20F”), which is an example of the user terminal 20 in the video game processing system 100 (see FIG. 1). The terminal 20F provided with a touch panel at least includes a specifying section 21F, an appearing section 22F, and an exerting section 23F in order to realize a video game in which a character digs through the ground in response to a touch operation.

The specifying section 21F has a function to specify an effect for which an exerting condition is satisfied in accordance with progress of the video game. In the present embodiment, the specifying section 21F specifies a skill, for which an exerting condition is satisfied, of “skills” set up for the character.

The appearing section 22F has a function to cause a plurality of icons corresponding to an effect to respectively appear at a plurality of positions in the game screen. In the present embodiment, the appearing section 22F causes the icons corresponding to the skill to respectively appear at a fixed position and an upper side of the character on the game screen, which is caused to appearance in the terminal 20.

The exerting section 23F has a function to exert an effect independently of positions of icons when any icon is selected. In the present embodiment, the exerting section 23F exerts an effect of a skill corresponding to an icon touched by a player.

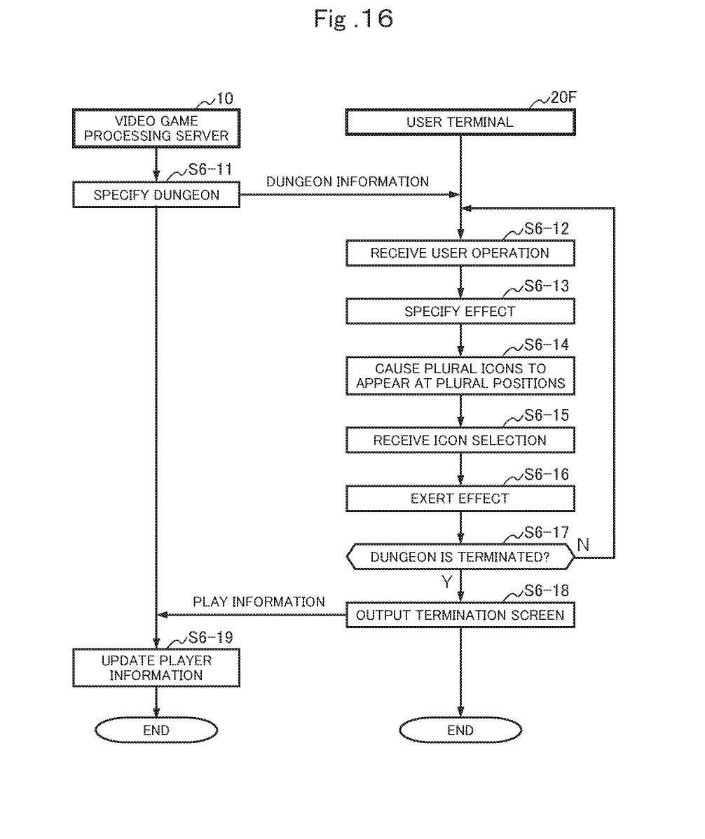

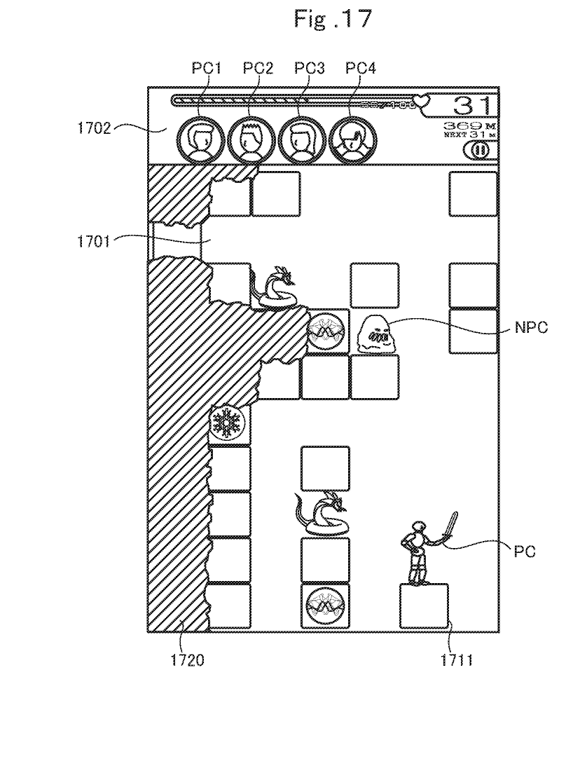

FIG. 16 is a flowchart showing an example of the game processing carried out by the system 100. Hereinafter, operations of the server 10 and the terminal 20F will be described as an example.

The game processing is started when the terminal 20F accesses the server 10, for example.

The server 10 specifies a dungeon to be provided to the terminal 20F in response to an access from the terminal 20F (Step S6-11). Here, the dungeon means a virtual space for which a clear condition is set up. In the present embodiment, the server 10 transmits information regarding the dungeon (hereinafter, referred to as “dungeon information”), which is to be provided to the terminal 20F, to the terminal 20F on the basis of the information (player information) regarding the player who operates the terminal 20F to play the video game. In this regard, the information regarding the dungeon (dungeon information) is stored in a storage device included in the server 10.

When the dungeon information is received from the server 10, the terminal 20 outputs a game screen by using the received dungeon information to receive a user operation (Step S6-12).

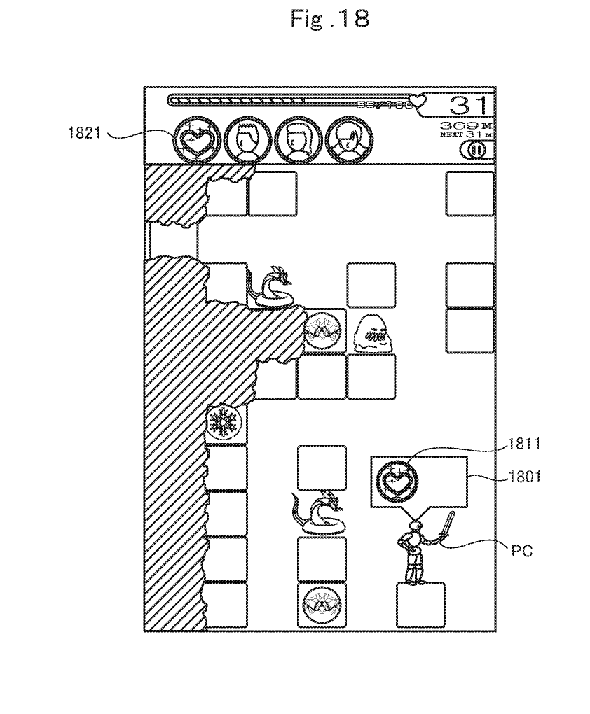

FIG. 17 is an explanatory drawing for explaining an example of a game screen outputted by the terminal 20F using the dungeon information. As shown in FIG. 17, an area 1701 (hereinafter, referred to as a “first area 1701”) in which the character operated by the player can move and an area 1702 (hereinafter, referred to as a “second area 1702”) in which information regarding the character is displayed are provided in the game screen.

Here, a character PC operated in response to an operation of the player (a player character PC), a non-player character (for example, an enemy character NPC), and a ground block (for example, block 1711) are displayed in the first area 1701.

The player character PC corresponds to at least one of a party constituted by four characters. In this regard, as the four characters, four character icons PC1, PC2, PC3, PC4 corresponding to the respective characters are displayed in the second area 1702. In this regard, a correspondence relationship between the player character PC and the four characters is not limited particularly. However, the video game processing system 100 may be configured so that the player character PC is treated in the video game as the other character representative of the four characters. Further, the configuration of the second area 1702 is not limited to this. However, for example, the video game processing system 100 may be configured so that skills and/or items corresponding to the respective characters are expressed in a mode in which the player is allowed to recognize probability of usage thereof and the number of use thereof.

Further, the non-player character is a character that attacks the player character PC. The player can defeat the non-player character by tapping a portion in which the non-player character is displayed. In the present embodiment, in a case where the player character PC defeats the non-player character, the player character PC can obtain an energy (or a point) for activating the skill. In this regard, the skills will be described later, but the player can use skills respectively having various effects by using or consuming energy that have been accumulated or collected.

Further, the ground block is an object that becomes an element of the video game. The player can cause the player character PC to dig the ground block by tapping a portion in which the ground block is displayed. Further, a gimmick (hereinafter, referred to as an “item in the video game”) may be buried in the ground block, the player can obtain the item in the video game by tapping the ground block. In this regard, ground blocks for which a predetermined condition is satisfied are displayed in the game screen, but ground blocks for which the predetermined condition is not satisfied are hidden by a dark image 1720. The content of the predetermined condition is not limited particularly. However, for example, various examples are thought such as a condition that a ground block is positioned within a predetermined distance from the player character PC, and a condition that a ground block within a predetermined distance is broken.

Further, the player character PC moves to a vicinity of the ground block tapped by the player. In this regard, it is no need that the moving method of the player character PC is limited to tapping of the ground block. For example, the video game processing system 100 may be configured so that the player character PC is moved to the vicinity of other object tapped by the player. Alternatively, the video game processing system 100 may be configured so that, in case of using a specific skill, the player character PC is moved to a position according to an effect of the skill.

Further, the game screen becomes a so-called automatic scrolling state. Namely, the terminal 20F moves the drawing range of the virtual space in a predetermined direction in accordance with the elapse of time. In the present embodiment, as one of failure conditions when the player play the dungeon, it is defined a case where the player character is not positioned in the drawing range. In this regard, as an example of a success condition, there is a case where the player character PC proceeds to a depth set up for the dungeon while playing by tapping by the number of times within a predetermined number of times by the player.

The terminal 20F outputs a game screen as described above, and causes the video game to proceed in response to a user operation. Then, the terminal 20F specifies an effect for which an exerting condition is satisfied in accordance with progress of the video game (Step S6-13). In the present embodiment, the terminal 20F specifies a skill for which the activating condition is satisfied.

When the effect is specified, the terminal 20F causes a plurality of icons to respectively appear at the plurality of positions in the game screen (Step S6-14). In the present embodiment, the terminal 20F outputs a game screen in which the plurality of icons (skill icons) corresponding the skill, for which the activating condition is satisfied, is arranged.

FIG. 18 is an explanatory drawing for explaining an example of the game screen outputted by the terminal 20. Here, a case where an activating condition of one skill is satisfied in accordance with progress of the video game will be described as an example. As shown in FIG. 18, a skill icon display area 1801, a first skill icon 1811, and a second skill icon 1821 are displayed on the game screen.

Here, the skill icon display area 1801 is an area in which an icon corresponding to a skill for which an activating condition is satisfied is displayed. The skill icon display area 1801 is displayed in the vicinity of the upper side of the player character PC in the first area 1701 (for example, overhead the player character PC). Further, the skill icon display area 1801 is erased after a predetermined period of time elapses since the skill icon display area 1801 was displayed. In this regard, the video game processing system 100 may be configured so that a plurality of skill icons is displayed in the skill icon display area 1801, or so that a skill icon corresponding to one skill for which the activating condition is newly satisfied is displayed in the skill icon display area 1801.

The first skill icon 1811 and the second skill icon 1821 are skill icons corresponding to one skill. The first skill icon 1811 is displayed in the skill icon display area 1801. Further, the second skill icon 1821 is displayed in place of the character icon in the second area. Namely, the second skill icon 1821 is displayed in a portion in which the character icon of the corresponding character (character provided with the skill) is displayed. In this regard, the two skill icons (the first skill icon and the second skill icon) corresponding to the one skill may have the same form or different forms. However, it is preferable that the form is a form by which the content of the skill can be suggested to the player.

When the game screen described above is outputted, the terminal 20F receives an icon selection (Step S6-15). In the present embodiment, the terminal 20 receives a tap operation with respect to a skill icon at arbitrary timing.

When the icon selection is received, the terminal 20F exerts an effect corresponding to the selected icon (Step S6-16). In the present embodiment, the terminal 20F carries out processing to exert the effect corresponding to the skill icon tapped by the player. Further, the terminal 20F erases the skill icon corresponding to the skill whose effect is exerted (for example, the first skill icon 1811 and the second skill icon 1821 in FIG. 18) from the game screen.

When the effect is exerted, the terminal 20F determines whether the dungeon is to be terminated or not (Step S6-17). In the present embodiment, the terminal 20F carries out termination determination of the dungeon on the basis of a predetermined termination condition. Here, in a case where it is determined that the dungeon is not to be terminated (“No” at Step S6-17), the terminal 20F continues the game processing.

On the other hand, in a case where it is determined that the dungeon is to be terminated (“Yes” at Step S6-17), the terminal 20F outputs a screen for informing the player that the dungeon is terminated (termination screen), and terminates the processing herein. In the present embodiment, the terminal 20F carries out predetermined processing in accordance with the dungeon termination to generate the termination screen, and transmits information regarding a result obtained after the player played the dungeon (hereinafter, referred to as “play information”) to the server 10. In this regard, as examples of the predetermined processing in accordance with the dungeon termination, there are continuation determination and privilege giving determination.

When the play information is received from the terminal 20F, the server 10 updates the player information on the basis of the received play information (Step S6-19), and terminates the processing herein.

As explained above, as one side of the sixth embodiment, the user terminal 20F is configured so as to include the specifying section 21F, the appearing section 22F, and the exerting section 23F. Therefore, it is possible to improve convenience of the icons that appears in the video game in which the screen is scrolled in one direction (for example, downward of the game screen).

Further, in the example of the sixth embodiment described above, the video game processing system 100 is configured so that the game screen is automatically scrolled. Therefore, by causing icons to appear in the vicinity of the upper side of the player character, it becomes possible to make it easy to understand that the effect can be exerted (that is, that a skill can be activated).

In this regard, in the example of the sixth embodiment described above, the case where the game screen is automatically scrolled has been described as an example. However, the video game processing may be configured so that the game screen is scrolled in response to the player operation in place of automatically scrolling. In this case, for example, the video game processing system 100 may be configured so that the game screen is scrolled downwardly when the ground block at a lower side of the game screen is dug (or destroyed).

In this regard, in the example of the sixth embodiment described above, the case where progress of the video game is controlled at the terminal side has been explained as an example. However, the configuration of the video game processing system 100 is not limited. For example, the video game processing system 100 may be configured so that the video game processing server 10 carries out various kinds of processing such as generation of a game screen. Alternatively, the video game processing system 100 may be configured so that the terminal 20F merely carries out transmission and reception of information and reception of an operation input. Namely, for example, the video game processing system 100 may be configured so that the game screens shown in FIG. 17 and FIG. 18 are outputted as a game screen of a cloud gaming.

As explained above, one or two or more shortages are solved by each of the embodiments of the present application. In this regard, the effects by each of the embodiments are non-limiting effects or one example of effects.

In this regard, in each of the embodiments described above, each of the plurality of user terminals 20 and 201 to 20N and the video game processing server 10 carries out the various kinds of processing described above in accordance with various kinds of control programs (for example, a video game processing program) stored in the storage device with which the corresponding terminal or server is provided.

Further, the configuration of the video game processing system 100 is not limited to the configuration that has been explained as the example of the respective embodiments described above. For example, the video game processing system 100 may be configured so that part or all of the processing that has been explained as the processing carried out by the user terminal is carried out by the server 10, or it may be configured so that part or all of the processing that has been explained as the processing carried out by the server 10 is carried out by any of the plurality of user terminals 20 and 201 to 20N (for example, the user terminal 20). Further, it may be configured so that a part or all of the storage sections included by the server 10 is included in any of the plurality of user terminals 20 and 201 to 20N. Namely, it may be configured so that a part or all of the functions included in any one of the user terminal 201 and the video game processing server 10 according to the video game processing system 100 is included in the other.

Further, the video game processing program may be configured so as to cause a single video game processing apparatus that does not include a communication network to realize a part or all of the functions that have been explained as the examples of the respective embodiments described above.

### APPENDIX

The explanation of the embodiments described above has been described so that the following inventions can be at least realized by a person having a normal skill in the art to which the present invention belongs.

(1)

A non-transitory computer-readable medium including a video game processing program product for causing a server to realize functions to control progress of a video game in response to an operation inputted to a terminal provided with a touch panel,

wherein the functions include:

a specifying function configured to specify an effect for which an exerting condition is satisfied in accordance with progress of the video game;

an appearing function configured to cause a plurality of icons corresponding to the effect to respectively appear at a plurality of positions in a game screen; and

an exerting function configured to exert, when any icon is selected, the effect independently of a position of the selected icon.

(2)

The non-transitory computer-readable medium according to claim (1),

wherein the appearing function includes a function configured to cause the icons to respectively appear at the plurality of positions including at least one of positions specified on the basis of a position of a character operated by a player of the video game.

(3)

The non-transitory computer-readable medium according to claim (1) or (2),

wherein the functions further include:

an adjusting function configured to adjust visibility of the icon, and

wherein the adjusting function includes a function configured to reduce visibility of the icon in accordance with progress of the video game by changing a form of the icon.

(4)

The non-transitory computer-readable medium according to any one of claims (1) to (3),

wherein a first area and a second area are provided in the game screen, a character operated by a player of the video game being capable of moving in the first area, information regarding the character being displayed in the second area, and

wherein the appearing function includes a function configured to cause the icons to respectively appear at the plurality of positions including a vicinity of the character in the first area and a fixed position provided in the second area.

(5)

The non-transitory computer-readable medium according to any one of claims (1) to (4),

wherein the appearing function includes:

a function configured to change a display form of a predetermined object on the game screen when the icon is caused to appear;

a function configured to return the display form of the predetermined object to a state before the change when the exerting function exerts the effect.

(6)

The non-transitory computer-readable medium according to any one of claims (1) to (5),

wherein the functions further include:

an erasing function configured to erase a part of the icons from the game screen when a predetermined period of time elapses since the appearing function causes the icons to appear, the erasing function being configured to erase, when the exerting function exerts the effect, all of the icons corresponding to the effect from the game screen.

(7)

The non-transitory computer-readable medium according to claim (6),

wherein the appearing function includes a function configured to cause icons, which are icons erased in a case where the predetermined period of time elapses and for which a corresponding effect has not been exerted, to appear in the game screen again when the plurality of icons corresponding to the effect for which the exerting condition is satisfied is caused to respectively appear at the plurality of positions in the game screen.

(8)

The non-transitory computer-readable medium according to any one of claims (1) to (7),

wherein the functions further include:

a storing function configured to store a plurality of effects, exerting conditions of the respective effects, icons of the respective effects, and a probability of exertion of each of the effects so as to be associated with each other, each of the effects being able to be exerted in accordance with progress of the video game; and

an updating function configured to update the probability of exertion of the effect both when the specifying function specifies the effect and the exerting function exerts the effect.

(9)

The non-transitory computer-readable medium according to any one of claims (1) to (8),

wherein the functions further include a scrolling function configured to scroll the display content of a virtual space in accordance with progress of the video game.

(10)

The non-transitory computer-readable medium according to any one of claims (1) to (9),

wherein a user terminal is caused to realize at least one function of the functions that the server is caused to realize, the user terminal being capable of communicating with the server.

(11)

A server in which the video game processing program described in any of claims (1) to (10) is installed.

(12)

A video game processing system including a communication network, a server and a user terminal, the video game processing system being configured to control progress of a video game in response to an operation inputted to a user terminal provided with a touch panel, the video game processing system comprising:

a specifying section configured to specify an effect for which an exerting condition is satisfied in accordance with progress of the video game;

an appearing section configured to cause a plurality of icons corresponding to the effect to respectively appear at a plurality of positions in a game screen; and

an exerting section configured to exert, when any icon is selected, the effect independently of a position of the selected icon.

(13)

The video game processing system according to claim (12),

wherein the server includes the specifying section, the appearing section, and the exerting section, and

wherein the user terminal includes an outputting configured to output the game screen on a display screen of a display device.

(14)

A non-transitory computer-readable medium including a video game processing program product for causing a server to realize a first group of functions to control progress of a video game in response to an operation inputted to a terminal provided with a touch panel, the video game processing program further causing the terminal to realize a second group of functions to carry out the video game,

wherein the first group of functions includes:

a specifying function configured to specify an effect for which an exerting condition is satisfied in accordance with progress of the video game;

an appearing function configured to cause a plurality of icons corresponding to the effect to respectively appear at a plurality of positions in a game screen; and

an exerting function configured to exert, when any icon is selected, the effect independently of a position of the selected icon,

wherein the second group of functions includes:

a receiving function configured to receive information for outputting the game screen received from the server.

(15)

A non-transitory computer-readable medium including a video game processing program product for causing a terminal to realize functions to control progress of a video game in response to an operation inputted to the terminal provided with a touch panel,

wherein the functions include:

a specifying function configured to specify an effect for which an exerting condition is satisfied in accordance with progress of the video game;

an appearing function configured to cause a plurality of icons corresponding to the effect to respectively appear at a plurality of positions in a game screen; and

an exerting function configured to exert, when any icon is selected, the effect independently of a position of the selected icon.

(16)

The non-transitory computer-readable medium according to claim (15),

wherein a server is caused to realize at least one function of the functions that the terminal is caused to realize, the server being capable of communicating with the terminal.

(17)

A terminal into which the video game processing program included in the non-transitory computer-readable medium according to claim (15) or (16) is installed.

(18)

A video game processing method of controlling progress of a video game in response to an operation inputted in a terminal provided with a touch panel, the video game processing method comprising:

specifying an effect for which an exerting condition is satisfied in accordance with progress of the video game;

causing a plurality of icons corresponding to the effect to respectively appear at a plurality of positions in a game screen; and

exerting, when any icon is selected, the effect independently of a position of the selected icon.

(19)

A video game processing method of controlling progress of a video game in response to an operation inputted to a terminal provided with a touch panel, the video game processing method being carried out by a video game processing system, the video game processing system including a communication network, a server and a user terminal, the video game processing method comprising:

specifying an effect for which an exerting condition is satisfied in accordance with progress of the video game;

causing a plurality of icons corresponding to the effect to respectively appear at a plurality of positions in a game screen; and

exerting, when any icon is selected, the effect independently of a position of the selected icon.

According to one of the embodiments of the present invention, it is useful to provide a player with a video game in which an icon with high functionality or convenience is displayed on a game screen.

What is claimed is:

1. A non-transitory computer-readable medium including a video game processing program product for causing a server to realize functions to control progress of a video game in response to an operation inputted to a terminal provided with a touch panel,
wherein the functions include:
a specifying function configured to specify an effect for which an exerting condition is satisfied in accordance with progress of the video game;
an appearing function configured to cause a plurality of icons corresponding to the effect to respectively appear at a plurality of positions in a game screen; and
an exerting function configured to exert, when any icon is selected, the effect independently of a position of the selected icon.

2. The non-transitory computer-readable medium according to claim 1,
wherein the appearing function includes a function configured to cause the icons to respectively appear at the plurality of positions including at least one of positions specified on the basis of a position of a character operated by a player of the video game.

3. The non-transitory computer-readable medium according to claim 1,
wherein a first area and a second area are provided in the game screen, a character operated by a player of the video game being capable of moving in the first area, information regarding the character being displayed in the second area, and
wherein the appearing function includes a function configured to cause the icons to respectively appear at the plurality of positions including a vicinity of the character in the first area and a fixed position provided in the second area.

4. The non-transitory computer-readable medium according to claim 1,
wherein the functions further include:
an erasing function configured to erase a part of the icons from the game screen when a predetermined period of time elapses since the appearing function causes the icons to appear, the erasing function being configured to erase, when the exerting function exerts the effect, all of the icons corresponding to the effect from the game screen.

5. A video game processing system including a communication network, a server and a user terminal, the video game processing system being configured to control progress of a video game in response to an operation inputted to a user terminal provided with a touch panel, the video game processing system comprising:
a specifying section configured to specify an effect for which an exerting condition is satisfied in accordance with progress of the video game;
an appearing section configured to cause a plurality of icons corresponding to the effect to respectively appear at a plurality of positions in a game screen; and
an exerting section configured to exert, when any icon is selected, the effect independently of a position of the selected icon.

6. A non-transitory computer-readable medium including a video game processing program product for causing a server to realize a first group of functions to control progress of a video game in response to an operation inputted to a terminal provided with a touch panel, the video game processing program further causing the terminal to realize a second group of functions to carry out the video game,
wherein the first group of functions includes:
a specifying function configured to specify an effect for which an exerting condition is satisfied in accordance with progress of the video game;
an appearing function configured to cause a plurality of icons corresponding to the effect to respectively appear at a plurality of positions in a game screen; and
an exerting function configured to exert, when any icon is selected, the effect independently of a position of the selected icon,
wherein the second group of functions includes:
a receiving function configured to receive information for outputting the game screen received from the server.
